(19) United States
(12) Patent Application Publication
(10) Pub. No.: US 2017/0233656 A1
(43) Pub. Date: Aug. 17, 2017

(54) METAL CAVITY INWALL DECOKING METHOD

(71) Applicant: LUO YANG RUICHANG PETRO-CHEMICAL EQUIPMENT CO., LTD, Henan (CN)

(72) Inventors: Song SHAO, Henan (CN); Xiaojing LU, Henan (CN); Bo LU, Henan (CN)

(73) Assignee: LUO YANG RUICHANG PETRO-CHEMICAL EQUIPMENT CO., LTD, Henan (CN)

(21) Appl. No.: 15/518,655

(22) PCT Filed: Sep. 15, 2015
(86) PCT No.: PCT/CN2015/000642

§ 371 Date: Apr. 12, 2017

(30) Foreign Application Priority Data
Oct. 14, 2014 (CN) 201410538437.0

(51) Int. Cl. C10B 43/02; B08B 7/04; B08B 9/093; C10B 43/08; B08B 9/027

(52) U.S. Cl. CPC C10B 43/02; C10B 43/08; B08B 9/027; B08B 9/093; B08B 7/04

(57) ABSTRACT

The present invention provides a metal cavity inwall decoking method, comprising:
a. Process sealed compression to the metal cavity;
b. Process rapid decompression to the metal cavity.

The present invention makes such substance as hydrocarbon volatiles, moisture and so on inside the coke gasify quickly because of fierce change of pressure differential by compressing and then decompressing the metal cavity rapidly, which makes the coke crush and fall off from the inwall of metal cavity and finally finish the decoking work. The decoking method claimed in the present invention is simply and convenient to operate, and can greatly increase the decoking efficiency.

### TECHNICAL FIELD

The present invention relates to a petrochemical industry technical field, specifically, involves a metal cavity inwall decoking method by compressing and then decompressing the metal cavity.

### BACKGROUND ART

In the petrochemical production field, especially in the process of catalytic cracking production, the macromolecular substance which doesn't vaporized in raw material or generated after conversion will condensate and deposit on the inwall of petrochemical equipment with dienes substance generated from high temperature cracking, and then condense to coke after long time stay in a relative high temperature situation. The largest harm of coking is to restrict the operation cycle of petrochemical equipment; increase repair frequency and influence the amount of finish as well. As a result, decoking is a regular job which needs to be proceeded regularly in petrochemical production field.

Most of present decoking processes use mechanical decoking method to relieve the coke, which applies an external mechanical force on the coke to break it up, and then washes the coke chips out. For example, a patent (application number 201410015365.1) claims a decoking equipment to relieve the coke, in which the equipment applies an external force to the coke mainly by using a hollow boring bit. For another example, a patent (application number 201220008669.1) claims an automatic decoking machine, which applies a shear force to the coke mainly by using water flow with high pressure. Moreover, a more advanced decoking method uses a kind of customized decoking ball which is ejected by a customized equipment. The coke is knocked into pieces by decoking balls which are ejected in high speed and generally made in rubber with spinous embossments on outside surface. Finally, the coke pieces are washed out.

Whichever methods above is taken, the same characteristic is to apply an external mechanical force to relieve the coke. But these methods all need customized large-scale cleaning equipment, which dissipate huge energy and take a long and complex process to clean.

### SUMMARY OF INVENTION

In the view of the defects of existing technology, the present invention aims to provide a metal cavity inwall decoking method.

According to one aspect of the present invention, it provides a metal cavity decoking method, comprising:

Step a: process sealed compression to the metal cavity;

Stop b: process rapid decompression to the metal cavity;

Preferably, it comprises step c after b, wherein: remove the coke residue fallen off from the metal cavity.

Preferably, the step c is processed by water wash or air purge.

Preferably, step a comprising: step a1, heat the metal cavity sealedly to raise its inner pressure.

Preferably, step b comprising: step b1, relieve the metal cavity from sealed state.

Preferably, step a comprising: step a2, supply air to the metal cavity in sealed state.

Preferably, the air claimed in step a2 is high pressure steam.

Preferably, step a comprising: step a3, heat and supply air to the metal cavity in sealed state.

Preferably, step b comprising: step b2, stop supplying air to the metal cavity, meanwhile, relieve the metal cavity from sealed state.

Preferably, step b comprising: step b3, stop supplying air to the metal cavity; and step b4, pump the metal cavity to vacuum state.

Preferably, it further comprises after step b1 or step b2: step b5, lower the temperature of the metal cavity rapidly.

The present invention makes substances inner the coke, such as hydrocarbon volatile, moisture and so on, gasify rapidly because of the fierce change of pressure differential by compressing the metal cavity and then decompressing it rapidly. It will make the cokes crack and fall off from the inwall of metal cavity, finally finish the decoking work. The present invention provides a quick and simple docoking method, which is easy to operate and can great increase the decoking efficiency.

### BRIEF DESCRIPTION OF DRAWINGS

By reading and consulting the detail descriptions to the non-limiting embodiments described by the following figures, the additional features, objectives and advantages of the present invention will be more obvious.

FIG.1 shows the first embodiment to the present invention, which is a flow chart of the metal cavity inwall decoking method.

FIG.2 shows the second embodiment to the present invention, which is a flow chart of the heating and pressurizing decoking method.

FIG.3 shows the third embodiment to the present invention, which is a flow chart of the air pressuring decoking method.

### DETAILED DESCRIPTION OF PREFERRED EMBODIMENTS

Combined with the figures and embodiments, the following article will further illustrate the technical contents of the present invention.

### Embodiment 1

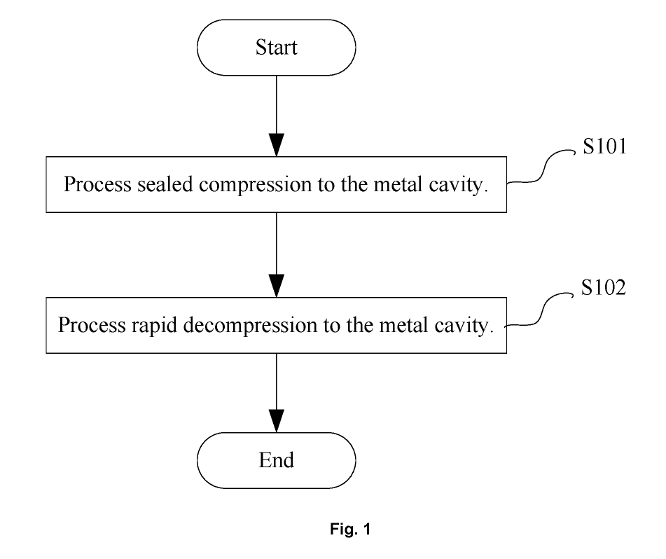

The following describes, as an embodiment of the metal cavity decoking method of the present invention, a metal cavity decoking method realized by the following steps in which is shown in FIG.1.

Step S101, process sealed compression to the metal cavity. Those skilled in the art understand that, the cavity of metal cavity can be any kind of metal equipment, for example: coking furnace, vacuum furnace, hydrogenation furnace, oil heating furnace and any kind of running piping. The metal cavity sealing method can take advantage of the self-device of the metal cavity, for example: sealed cap, check valve and so on, it can also use specialized sealing device, for example: sealed top cap with hydraulic device. Moreover, when processing sealed compression to the metal cavity (step S101), not only the metal cavity itself will be affected by pressure, but the cokes stick on the inwall of metal cavity will also be affected by pressure. Under the action of the pressure, the metal cavity and the cokes will produce various swelling deformation, at the same time, as the coke is comprised of substances including ash content, carbide, hydrocarbon volatile, moisture and so on, the coke itself will produce various sizes of internal stress among the components mentioned above. As a kind of change, the metal cavity can be unsealed. In this case, the unsealed metal cavity is put directly into a sealed container. Then compress the sealed container.

Furthermore, based on the step S101, process step S102: process rapid decompression to the metal cavity. Those skilled in the art understand that, the pressure differential inner the metal cavity will change fiercely when processing sudden decompression to the metal cavity. As the size of deformation of metal cavity various from the one of cokes, the inwall joint face of metal cavity and the cokes will separate from each other. What's more, substance such as hydrocarbon volatile, moisture and so on will gasify rapidly because of the fierce change of pressure differential. The coke will crack and even burst in the process of gas inside-outside release, which will make the coke fall off from the inwall of metal cavity. So that, after processing step S101 and step S102, the coke will burst itself and fall off from the inner of metal cavity, then finish the key step of the decoking method.

Furthermore, those skilled in the art understand that, the cavity of the metal cavity can be any kind of metal equipment, such as coking furnace, vacuum furnace, hydrogenation furnace, oil heating furnace and all kinds of running piping. After the embodiment 1 carries out, the fallen cokes will remain in the metal cavity. If the volume of metal cavity is small enough, or the metal cavity is put on vertical direction, the cracked and fallen cokes can be easily cleared away from the inner of metal cavity without specialized wash process.

If the metal cavity is put on horizontal direction, or its inner structure is too complex, a process will be taken to clear away the coke residue. Those skilled in the art understand that, the present coke residue clearing away process is different from traditional wash process of decoking method. The traditional wash process of decoking method generally uses high pressure jet to provide mechanical shear force which is large enough to wash the coke out. In the present invention, it just needs conventional wash step, for the step S101 and S102 have already separated the coke from the metal cavity.

Preferably, the coke residue clearing away process can be realized by water washing or air purging. When using water to wash the metal cavity, it needs conventional stream to wash, generally doesn't need to compress the stream by using specialized high pressure pump. If the inner structure of metal cavity is quite complex, sprayers in different shape can be used to wash dead zones where stream cannot reach. When taking air purge method, it preferably use air pump connected with industrial gas nozzle to purge and wash the metal cavity. Those skilled in the art understand that, when the volume of metal cavity is quite small, the air purge method is more suitable than water wash method in efficiency.

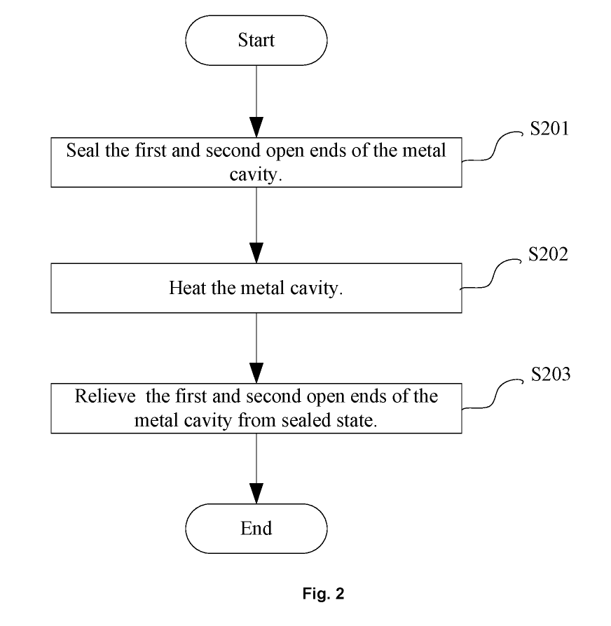

Preferably, the following describes, as an embodiment of decoking method of the present invention by heating and compressing the metal cavity, a metal cavity decoking method realized by the following steps in which is shown in FIG.2.

Step S201, seal the first and second open ends of the metal cavity. The sealing method to the metal cavity can take usage of the self-device of the metal cavity, for example: sealed cap, check valve and so on, it can also use specialized sealing device, for example: sealed top cap with hydraulic device. As the sealing method doesn't affect the essential content of the present invention, it requires minimal space here. Those skilled in the art understand that, this step is mainly taken to prepare for processing step S202, as to ensure that the pressure in the metal cavity can rise persistently when processing step S202.

Furthermore, process step S202: heat the metal cavity, on the base of step S201. Those skilled in the art understand that, the pressure inside the metal cavity will rise under the action of thermodynamics after the metal cavity is heated, meanwhile, as the metal cavity is sealed, the pressure inside the metal cavity will rise persistently. Actually, the effect of step S202 is to compress the metal cavity, moreover, what effect the present step will do to the metal cavity and coke has already mentioned in embodiment 1, it takes minimal space here. The heating process also brings out extra effect, as the CTE of metal cavity is different from the CTE of coke under the action of thermodynamics, the different expansive degree of metal cavity and coke will urge the coke fall off from the inwall of metal cavity. As a result, the heating and compressing method can speed up the crush and fall off process of coke, compared with traditional compressing method in normal temperature.

Furthermore, step S203 can be processed to decompress the metal cavity rapidly, on the base of step S202, which comprising relieve the first and second open ends of the metal cavity from sealed state. Those skilled in the art understand that, the pressure inside the metal cavity is larger than that outside the metal cavity when the sealed state is relived. So that plenty of high pressure gas inside the metal cavity will rush out in moment and then produce fierce pressure differential in the metal cavity. Meanwhile, as the CTE of metal cavity is also different from that of coke, the coke will fall off from the inwall of metal cavity on the action of stress when pressure differential change fiercely, and finally finish decoking work.

In a further case, the metal cavity can be vacuumized after processing step S203 to strong the change of pressure differential. Those skilled in the art understand that, the larger the change of pressure differential, the more chance of coke to crush and fall off from the inwall of metal cavity. So that, the increased step to vacuumize the metal cavity can optimize the decoking effect.

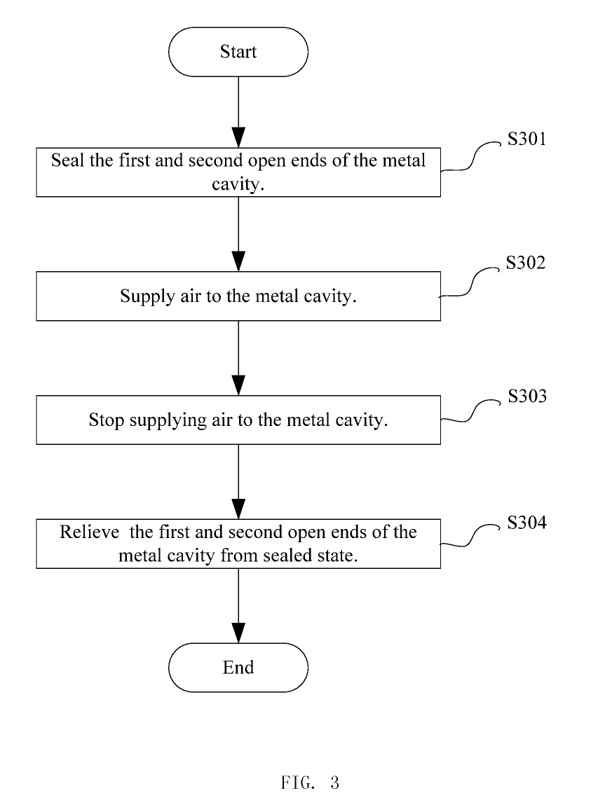

Preferably, the following describes, as an embodiment of decoking method of the present invention by supplying air to the metal cavity and compressing it, a metal cavity decoking method realized by the following steps in which is shown in FIG.3.

Step S301, seal the first and second open ends of the metal cavity. Those skilled in the art understand that, the step S301 is equal to the step S201, which needs minimal space here.

Furthermore, process step S302: supply air to the metal cavity, on the base of step S301. Those skilled in the art understand that, the present step is actually the traditional supplying air and compressing method, which can be realized by many ways. For example, air pump can be taken to supply ordinary pressure air to the metal cavity. With the increase of gas flow inside the metal cavity, the inner pressure of metal cavity will increase little by little. In a further example, a high pressure pump can be taken to supply high pressure air to the metal cavity, which faster the speed of compression. The final effect of the present step is to increase the inner pressure of the metal cavity, moreover, the effect of the present step on the metal cavity and coke has already mentioned in the embodiment 1, which needs minimal space here.

In a further case, the step S202 can be processed after step S302, in which heat the metal cavity after supplying air to and compressing it. The increased heating step can not only increase the compression speed, but can also urge the coke fall off from the inwall of metal cavity by

taking advantage of the difference of CTE between the coke and metal cavity, increase decoking efficiency. Those skilled in the art understand that, the step S202 can also be taken before the step S302, it doesn't matter the realization of the present embodiment, which needs minimal space here.

In another case, step S202 and step S302 can be replaced by supplying high pressure steam directly to the metal cavity, which can realize the heating compressing step and supplying air compressing step at the same time. Moreover, those skilled in the art understand that the advantage of supplying high pressure steam is that the high pressure steam has high water content, the steam can intrude into the gap of coke and speed up the crushing effect of coke.

Furthermore, process step S303 and step S304 after processing step S302. The step S303 and step S304 comprising stop supplying air to the metal cavity and relieve the first and second open ends of it from the sealed state. The theory and effect of the present step equal to those of step S203, which have already mentioned above and need minimal space here. Meanwhile, as a further case, the metal cavity can also be vacuumized after air is stopped supplying to it. The vacumizing step has already mentioned above which needs minimal space here.

In a further case, in the embodiment which process the step S202, the step of lowering the temperature of the metal cavity rapidly can also be processed. Those skilled in the art understand that, the substance of the present invention is to take advantage of the different degree of expansion between metal cavity and coke, when fierce change of pressure differential affect on them. The difference above urges the coke crush itself and fall off from the inwall of metal cavity. The advantage of increasing the present step is to take advantage of the fierce change of temperature difference and the pressure differential. As the degree of expansion of metal cavity and coke also differ from each other when the temperature difference changes fiercely. This can further assist the coke crush itself and fall off from the inwall of metal cavity. Furthermore, those skilled in the art understand that, the coke generally comprises ash content, carbide, hydrocarbon volatiles, moisture and so on, and the material of metal cavity is metal, the CTE and shrinkage rate after cooling of the metal cavity and coke differ from each other. As a result, lower the temperature rapidly after processed heating step to rise the temperature of coke and metal cavity can produce different inner stress between the substances of coke and the metal cavity. Finally, the coke will crush itself and fall off from the inwall of metal cavity under the action of inner stress.

The above describes the embodiments of the present invention. And what is needed to understand is that, the present invention is not limited to the specific mode of execution mentioned above, those skilled in the art can transform and modify the embodiments in the range of claims, which doesn't matter the essential content of the present invention.

1. A metal cavity inwall decoking method comprising:
step a. Process sealed compression to the metal cavity;
step b. Process rapid decompression to the metal cavity;

2. The metal cavity inwall decoking method of claim 1, further comprising:
step c. Remove the coke residue fallen off from the metal cavity.

3. The metal cavity inwall decoking method of claim 2, wherein: the step c is processed by water wash or air purge.

4. The metal cavity inwall decoking method of claim 1, wherein the step a comprising:
step a1. Heat the metal cavity sealedly to raise its inner pressure.

5. The metal cavity inwall decoking method of claim 2, wherein the step b comprising:
step b1. Relieve the metal cavity from sealed state.

6. The metal cavity inwall decoking method of claim 1, wherein the step a comprising:
step a2. Supply air to the metal cavity in sealed state.

7. The metal cavity inwall decoking method of claim 6, wherein: the air claimed in step a2 is high pressure steam.

8. The metal cavity inwall decoking method of claim 1, wherein the step a comprising:
step a3. Heat and supply air to the metal cavity in sealed state.

9. The metal cavity inwall decoking method of claim 4, wherein the step b comprising:
step b2. Stop supplying air to the metal cavity, meanwhile, relieve the metal cavity from sealed state.

10. The metal cavity inwall decoking method of claim 4, wherein the step b comprising:
step b3. Stop supplying air to the metal cavity;
step b4. Pump the metal cavity to vacuum state.

11. The metal cavity inwall decoking method of claim 7, wherein the step b2 further comprising after step b2:
step b5. Lower the temperature of the metal cavity rapidly.

12. The metal cavity inwall decoking method of claim 5, wherein the step b1 further comprising after step b1:
step b5. Lower the temperature of the metal cavity rapidly.

13. The metal cavity inwall decoking method of claim 5, wherein the step b comprising:
step b2. Stop supplying air to the metal cavity, meanwhile, relieve the metal cavity from sealed state.

14. The metal cavity inwall decoking method of claim 6, wherein the step b comprising:
step b2. Stop supplying air to the metal cavity, meanwhile, relieve the metal cavity from sealed state.

15. The metal cavity inwall decoking method of claim 5, wherein the step b comprising:
step b3. Stop supplying air to the metal cavity;
step b4. Pump the metal cavity to vacuum state.

16. The metal cavity inwall decoking method of claim 6, wherein the step b comprising:
step b3. Stop supplying air to the metal cavity;
step b4. Pump the metal cavity to vacuum state.
